(19) United States
(12) Patent Application Publication
(10) Pub. No.: US 2005/0195200 A1
(43) Pub. Date: Sep. 8, 2005

(54) Embedded system with 3D graphics core and local pixel buffer

(76) Inventors: Dan Minglun Chuang, San Diego, CA (US); Nidish Ramachandra Kamath, Placentia, CA (US)

Correspondence Address: Qualcomm Incorporated;Patents Department, 5775 Morehouse Drive, San Diego, CA, 92121-1714, US

(21) Appl. No.: 10/951,407

(22) Filed: Sep. 27, 2004

Related U.S. Application Data
(60) Provisional application No. 60/550,027, filed on Mar. 3, 2004.

(51) Int. Cl. G06F 15/16; G06F 13/14

(52) U.S. Cl. 345/519

(57) ABSTRACT

An embedded device is provided which comprises a device memory and hardware entities including a 3D graphics entity. The hardware entities are connected to the device memory, and at least some of the hardware entities perform actions involving access to and use of the device memory. A grid cell value buffer is provided, which is separate from the device memory. The buffer holds data, including buffered grid cell values. Portions of the 3D graphics entity access the buffered grid cell values in the buffer, in lieu of the portions directly accessing the grid cell values in the device memory, for per-grid processing by the portions.

### CROSS REFERENCE TO RELATED APPLICATIONS

This application claims the benefit of provisional U.S. Application Ser. No. 60/550,027, entitled “Pixel-Based Frame Buffer Prefetch Cache for 3D Graphics,” filed Mar. 3, 2004.

### COPYRIGHT NOTICE

This patent document contains information subject to copyright protection. The copyright owner has no objection to the facsimile reproduction by anyone of the patent document or the patent, as it appears in the U.S. Patent and Trademark Office files or records, but otherwise reserves all copyright rights whatsoever.

### BACKGROUND OF THE INVENTION

The present invention is related to embedded systems having 3D graphics capabilities. In other respects, the present invention is related to a graphics pipeline, a mobile phone, and memory structures for the same.

Embedded systems, for example, mobile phones, have limited memory resources. A given embedded system may have a main memory and a system bus, both of which are shared by different system hardware entities, including a 3D graphics chip.

Meanwhile, the embedded system 3D chip requires large amounts of bandwidth of the main memory via the system bus. For example, a 3D graphics chip displaying 3D graphics on a quarter video graphics array (QVGA) 240×320 pixel screen, at twenty frames per second, could require a memory bandwidth between 6.1 MB per second and 18.4 MB per second, depending upon the complexity of the application. This example assumes that the pixels include only color and alpha components.

Memory bandwidth demands like this can result in a memory access bottleneck, which could adversely affect the operation of the 3D graphics chip as well as of other hardware entities that use the same main memory and system bus.

### BRIEF SUMMARY OF THE INVENTION

An embedded device is provided which comprises a device memory and hardware entities including a 3D graphics entity. The hardware entities are connected to the device memory, and at least some of the hardware entities perform actions involving access to and use of the device memory. A grid cell value buffer is provided, which is separate from the device memory. The buffer holds data, including buffered grid cell values. Portions of the 3D graphics entity access the buffered grid cell values in the buffer, in lieu of the portions directly accessing the grid cell values in the device memory, for per-grid cell processing by the portions.

Other features, functions, and aspects of the invention will be evident from the Detailed Description of the Invention that follows.

### BRIEF DESCRIPTION OF THE SEVERAL VIEWS OF THE DRAWINGS

The present invention is further described in the detailed description, which follows, by reference to the noted drawings by way of non-limiting exemplary embodiments, in which like reference numerals represent similar parts throughout the several views of the drawings, and wherein:

FIG. 1 is a block diagram of an embedded device;

FIG. 2 is a more detailed block diagram of a main memory, a system bus, and a 3D graphics entity processor of the embedded device shown in FIG. 1;

FIG. 3 is a flow chart of a per-triangle processing process which may be performed by certain 3D graphics pipeline stages of the illustrated 3D graphics entity;

FIG. 4 is a schematic diagram of an exemplary embodiment of a blending block which may form part of the illustrated 3D graphics pipeline;

FIG. 5 illustrates a frame buffer and an example linear address mapping scheme;

FIG. 6 is a simplified screen depiction of a set of triangles forming part of a given 3D image;

FIG. 7 is a schematic diagram of an example cache subsystem;

FIG. 8 is a block diagram of a graphics entity comprising, among other elements, a depth buffer memory; and

FIG. 9 is a timing diagram for the depth buffer memory illustrated in FIG. 8.

### DETAILED DESCRIPTION OF THE INVENTION

To facilitate an understanding of the following Detailed Description, definitions will be provided for certain terms used therein. A primitive may be, e.g., a point, a line, or a triangle. A triangle may be rendered in groups of fans, strips, or meshes. An object is one or more primitives. A scene is a collection of models and the environment within which the models are positioned. A pixel comprises information regarding a location on a screen along with color information and optionally additional information (e.g., depth). The color information may, e.g., be in the form of an RGB color triplet. A screen grid cell is the area of a screen that may be occupied by a given pixel. A screen grid value is a value corresponding to a screen grid cell or a pixel. An application programming interface (API) is an interface between an application program on the one hand and operating system, hardware, and other functionality on the other hand. An API allows for the creation of drivers and programs across a variety of platforms, where those drivers and programs interface with the API rather than directly with the platform's operating system or hardware.

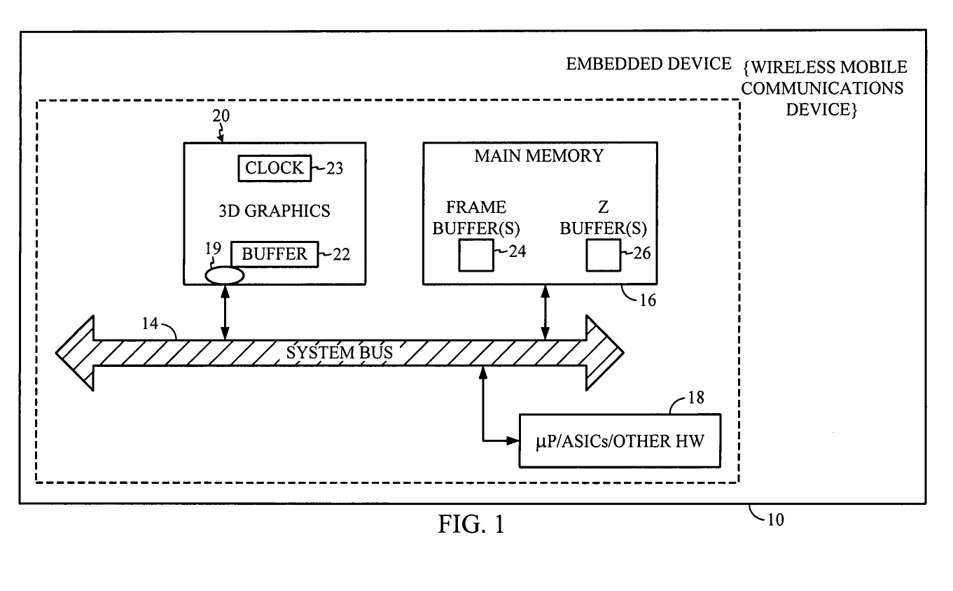

FIG. 1 is a block diagram of an exemplary embedded device 10, which in the illustrated embodiment comprises a wireless mobile communications device. The illustrated embedded device 10 comprises a system bus 14, a device memory (a main memory 16 in the illustrated system) connected to and accessible by other portions of the embedded device through system bus 14, and hardware entities 18 connected to system bus 14. At least some of the hardware entities 18 perform actions involving access to and use of main memory 16.

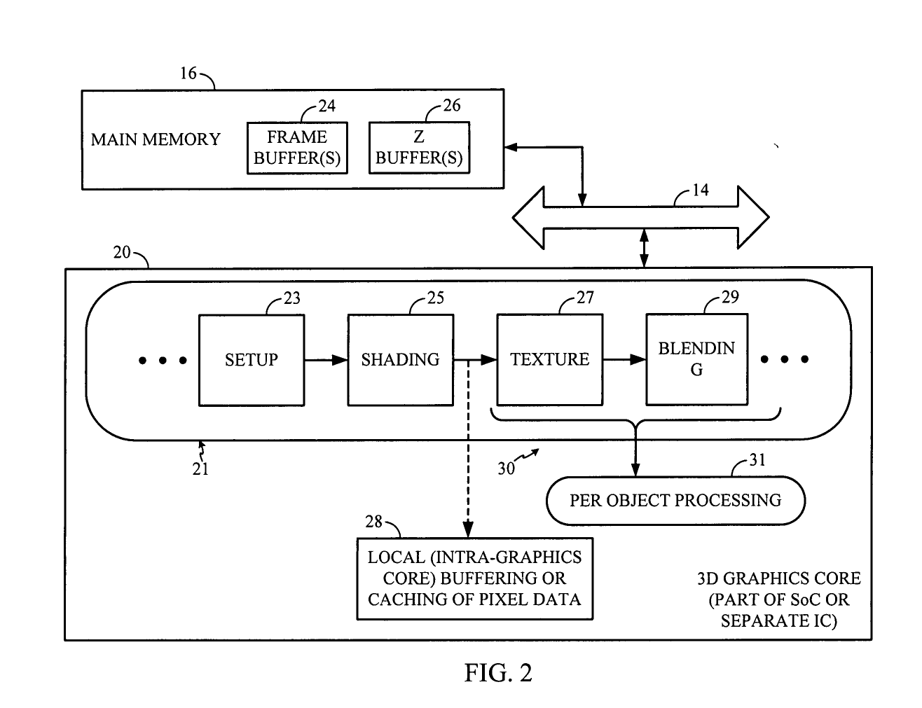

A 3D graphics entity 20 is connected to system bus 14. 3D graphics entity 20 may comprise a core of a larger integrated system (e.g., a system on a chip (SoC)), or it may comprise a 3D graphics chip, such as a 3D graphics accelerator chip. The 3D graphics entity comprises a graphics pipeline (see FIG. 2), a graphics clock 23, a buffer 22, and a bus interface 19 to interface 3D graphics entity 20 with system bus 14. Data exchanges within 3D graphics entity 20 are clocked at the graphics clock rate set by graphics clock 23.

Buffer 22 holds data used in per-pixel processing by 3D graphics entity 20. Buffer 22 provides local storage of pixel-related data, such as pixel information from buffers within main memory 16, which may comprise one or more frame buffers 24 and Z buffers 26. Frame buffers 24 store separately addressable pixels for a given 3D graphics image; each pixel is indexed with X (horizontal position) and Y (vertical position) screen position index integer values. Frame buffers 24, in the illustrated system, comprise, for each pixel, RGB and alpha values. In the illustrated embodiment, Z buffer 26 comprises depth values Z for each pixel.

FIG. 2 is a block diagram of main memory 16, system bus 14, and certain portions of 3D graphics entity 20. As shown in FIG. 2, 3D graphics entity 20 comprises a graphics pipeline 21. The illustrated graphics pipeline 21 comprises, among other elements not specifically shown in FIG. 2, certain graphics pipeline stages comprising a setup stage 23, a shading stage 25, and succeeding graphics pipeline stages 30. The succeeding graphics pipeline stages 30 shown in FIG. 2 include a texturing stage 27 and a blending stage 29.

A microprocessor (one of hardware entities 18) and main memory 16 operate together to execute an application program (e.g., a mobile phone 3D game, a program for mobile phone shopping with 3D images, or a program for product installation or assembly assistance via a mobile phone) and an application programming interface (API). The API facilitates 3D rendering for a application, by providing the application with access to the 3D graphics entity. The application may be developed in a work station or desktop personal computer, and then loaded to the embedded device, which in the illustrated embodiment comprises a wireless mobile communications device (e.g., a mobile phone).

Setup stage 23 performs computations on each of the image's primitives (e.g., triangles). These computations precede an interpolation stage (otherwise referred to as a shading stage 25 or a primitive-to-pixel conversion stage) of the graphics pipeline. Such computations may include, for example, computing the slope of a triangle edge using vertex information at the edge's two end points. Shading stage 25 involves the execution of algorithms to define a screen's triangles in terms of pixels addressed in terms of horizontal and vertical (X and Y) positions along a two-dimensional screen. Texturing stage 27 matches image objects (triangles, in the embodiment) with certain images designed to add to the realistic look of those objects. Specifically, texturing stage 27 will map a given texture image by performing a surface parameterization and a viewing projection. The texture image in texture space (u,v) (in texels) is converted to object space by performing a surface parameterization into object space (x₀, y₀, z₀). The image in object space is then projected into screen space (x, y) (pixels), onto the object (triangle).

In the illustrated embodiment, blending stage 29 takes a texture pixel color from texture stage 27 and combines it with the associated triangle pixel color of the pre-texture triangle. Blending stage 29 also performs alpha blending on the texture-combined pixels, and performs a bitwise logical operation on the output pixels. More specifically, blending stage 29, in the illustrated system, is the last stage in 3D graphics pipeline 21. Accordingly, it will write the final output pixels of 3D graphics entity 20 to frame buffer(s) 24 within main memory 16. An additional graphics pipeline stage (not shown) may be provided between shading stage 25 and texturing stage 27. That is, a hidden surface removal (HSR) stage (not shown) may be provided, which uses depth information to eliminate hidden surfaces from the pixel data—thereby simplifying the image data and reducing the bandwidth demands on the pipeline.

A local buffer 28 is provided, which may comprise a buffer or a cache. Local buffer 28 buffers or caches pixel data obtained from shading stage 25. The pixel data may be provided in buffer 28 from frame buffer 24, after population of frame buffer 24 by shading stage 25, or the pixel data may be stored directly in buffer 28, as the pixel data is interpolated in shading stage 25.

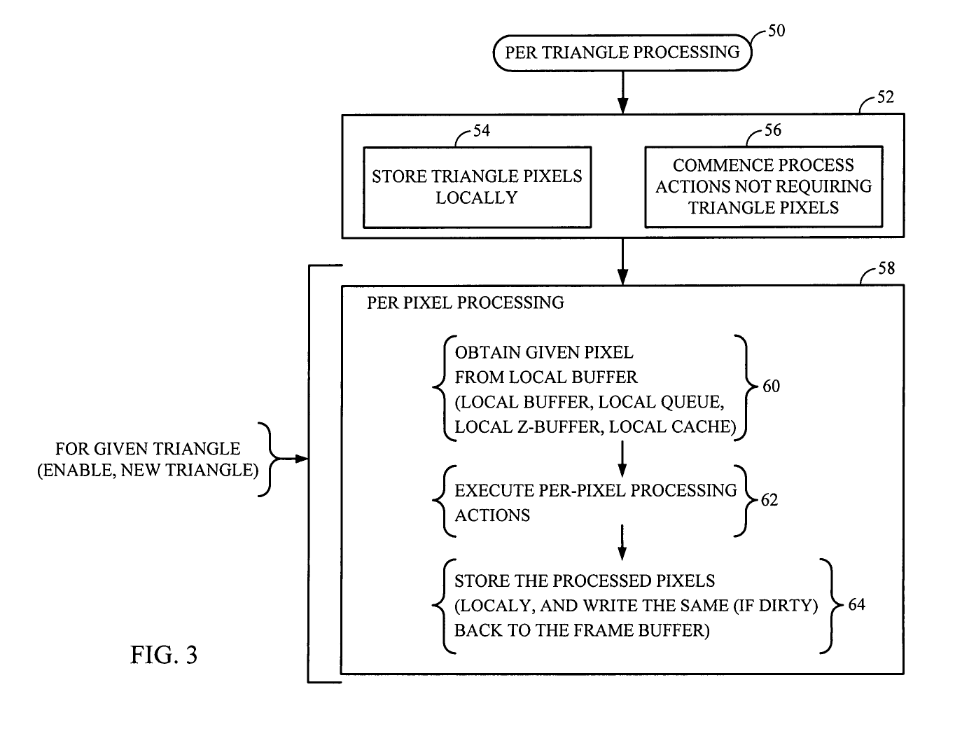

As shown in FIG. 2, the later stages of graphics pipeline 21 perform per-object (per-triangle) processing functions. The mapping process involved in texturing, and the subsequent blending for a given triangle, are examples of such per-triangle processing functions. FIG. 3 is a flow diagram illustrating per-triangle processing 50. Per-triangle processing is performed for each triangle within the image, and involves the preliminary processing of data (act 56) and local storage of triangle pixels (act 54) in act 52, and subsequent per-pixel processing 58. Each of these acts will be performed for a given triangle upon the initiation of an “enable new triangle” signal received by the per-object processing portions of the graphics pipeline.

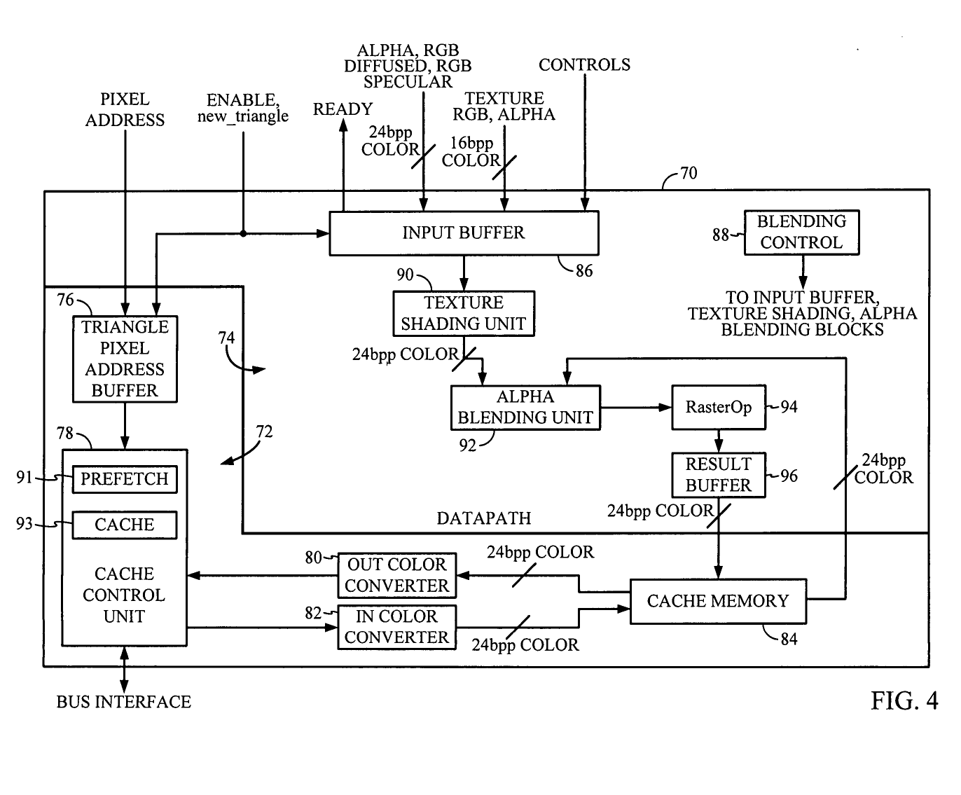

More specifically, in act 52, the triangle pixels for the given triangle will be stored locally at act 54, and the per-triangle processing will commence process actions not requiring triangle pixels at act 56. Actions not requiring triangle pixels may include, for example, the inputting of alpha, RGB diffused, and RGB specular data; the inputting of texture RGB, and alpha data; and the inputting of control signals, all to an input buffer (see input buffer 86, in FIG. 4).

In a per-pixel processing act 58, a given pixel is obtained from the local buffer at act 60. The per-pixel processing actions are then executed on the given pixel at act 62. In act 64, the processed pixels of the triangle are stored locally and written back to the frame buffer (if the processed pixel is now dirty).

The local buffer from which the given pixel is obtained (in act 60) may comprise a local buffer, a local queue, a local Z-buffer, and/or a local cache. In the illustrated embodiment, the local buffer comprises a local cache dedicated to frame buffer data used in per-pixel processing by the 3D graphics pipeline. The cache comprises a pixel buffer mechanism to buffer pixels and to allow access to and processing of the buffered pixels by later portions of the graphics pipeline (in the illustrated embodiment, the texturing and blending stages). Those portions succeed the shading portion of the graphics pipeline. In the illustrated embodiment, those portions are separate graphics pipeline stages.

The per-triangle processing portion of the graphics pipeline, together with the 3D graphics cache, collectively comprise a new object enable mechanism to enable prefetching by the cache of pixels of the new object (a triangle in the illustrated embodiment). The per-object processing portion of the graphics pipeline processes portions of the new triangle pixels. Where processed pixels from a previous triangle coinciding with the new triangle pixels are already in the cache, the cache does not prefetch those coinciding pixels.

FIG. 4 is the block diagram of a post-shading (i.e., post primitive-to-pixel conversion) per-triangle processing portion of the illustrated 3D graphics entity. The illustrated circuitry 70 comprises a cache portion 72 and a blending portion 74. The illustrated cache portion 72 comprises a triangle pixel address buffer 76, a cache control unit 78, an out color converter 80, an in color converter 82, and a frame buffer prefetch cache 84. Cache control unit 78 comprises a prefetch mechanism 91 and a cache mechanism 93.

Triangle pixel address buffer 76 has a pixel address input for identifying the address of a first pixel of the current cache line corresponding to the triangle being currently processed by per-triangle processing portion 70. Triangle pixel address buffer 76 also has an “enable, new triangle” input, for receiving a signal indicating that a new triangle is to be processed and enabling operation of the cache, at which point memory accesses are checked within the contents of the cache, and, when there is a cache miss, memory requests are made through the bus interface.

Blending portion 74 comprises an input buffer 86, a blending control portion 88, a texture shading unit 90, an alpha blending unit 92, a rasterization code portion (RasterOp) 94, and a result buffer 96.

Input buffer 86 has an output for indicating that it is ready for input from the texture stage. It comprises inputs: for alpha RGB diffused and RGB specular data; for texture RGB and alpha data; and for controls. It also has an input that receives the “enable, new triangle” signal. Input buffer 86 outputs the appropriate data for use by texture shading unit 90, which forwards pixel values to alpha blending unit 92. Alpha blending unit 92 receives input pixels from frame buffer prefetch cache 84, and is thus able to blend the texture information with the pre-textured pixel information from the frame buffer via frame buffer prefetch cache 84. The output information from alpha blending unit 92 is forwarded to RasterOp device 94, which executes the rasterization code. The results are forwarded to result buffer 96, which returns each pixel to its appropriate storage location within frame buffer prefetch cache 84.

A given pixel may be represented using full precision in the graphics core, while its precision may be reduced when packing in the frame buffer. Accordingly, a given pixel may comprise 32 bits of data, allowing for eight bits for each of R, G, and B, and eight bits for an alpha value. At the same resolution, if the depth value Z is integrated into each pixel, each pixel will require 48 bits. Each such pixel may be packed, thereby reducing its precision, as it is stored in cache 84. Out color converter 82 and in color converter 84 are provided for this purpose, i.e., out color converter 80 converts 24 bit pixel data to 32 bit pixel data, while in color converter 82 converts 32 bit pixel data to 24 bit pixel data.

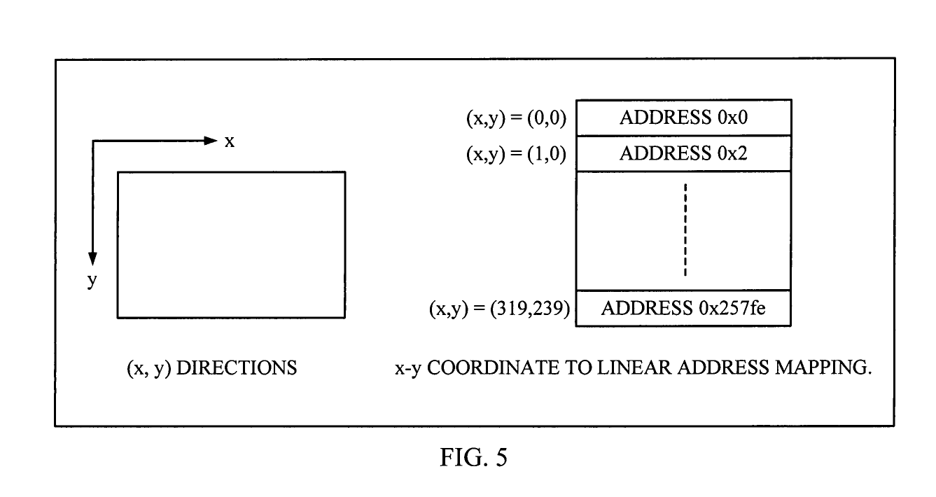

FIG. 5 illustrates that a given frame buffer may have an addressing scheme based on pixel indices, i.e., in terms of X and Y screen position values for the respective pixels. Those pixels may be mapped linearly to memory addresses, as shown in FIG. 5. Particularly, the pixels in the frame buffer may be mapped to linear memory addresses, starting from the upper-left corner to the lower-right corner of the screen. For example, if each pixel value (R,G,B or A) is a half-word (4 bits), for a color depth of 16 bpp, then the memory byte address as shown in FIG. 5 increments by two per pixel. Each scan line (row) of a 320×240 frame buffer is 320 pixels or 640 byte addresses.

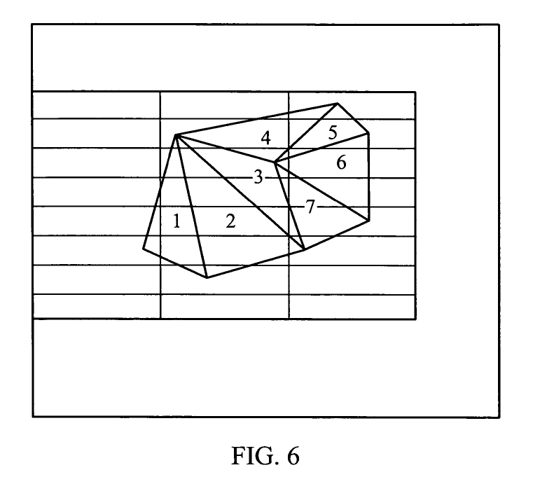

FIG. 6 is a simplified screen representation of a cluster of fans, made up of triangles 1-7. The cache takes advantage of the local nature of the triangle rendering order, assuming the triangles are rendered in clusters of fans, strips, or meshes, as shown in FIG. 6. In FIG. 6, gray rectangles represent the arrangement of cache lines as mapped to the screen. If a given cache line size is selected correctly, the blending block shown in FIG. 4 can take advantage of the burst access efficiency of the memory system.

Referring back to FIG. 4, cache portion 72 comprises a frame buffer prefetch cache 84, which comprises a pixel-centric write-back data cache 93 and a prefetch mechanism 91. The illustrated cache mechanism 93 may simply comprise a standard direct-mapped cache. More complex cache mechanisms may be provided for more set associativity, for added performance at the expense of circuit area and power consumption.

Every time a cache miss occurs, checked on a per-cache-line basis grouped from the linear pixel address inputs, the missed cache line is fetched by prefetch mechanism 91. That fetch occurs through accessing the frame buffers stored in main memory 16 via system bus 14. A write back of a cache line will occur when the cache line is missed and the associated dirty bit is set or when the whole cache is invalidated. The size of a cache line is based on a given integer number of pixels. In the illustrated embodiment, the cache line size is eight consecutive pixels with a linear pixel addressing scheme, disassociating the cache from varying frame buffer formats in the system. This translates to 16 bytes in consecutive memory addresses for a 16 bpp frame buffer, 24 bytes for a 24 bpp frame buffer, and 32 bytes for a 32 bpp frame buffer.

The illustrated prefetching mechanism 91 takes advantage of the processing time in the blending process, and prefetches a next cache line identified by the next triangle pixel address within triangle pixel address buffer 76. Before the next cache line pixel group arrives at blending portion 74, the cache line accesses for that group are prefetched. Prefetch mechanism 91 determines if the next cache line access is a cache miss. If the cache line access is also “dirty,” the cache content is written-back before performing the prefetch associated with the cache miss. In this way, cache line fetches are pipelined with the pixel processing time of the next group of pixels, and the pixel processing time is hidden inside the bus access delay, which further reduces the effect of the bus access delay.

A collection of cache lines, e.g., 64 cache lines or 512 pixels, makes up a complete cache. The number of cache lines can be increased (thereby increasing the size of the cache) to gain performance, again at the expense of circuit area and power consumption. Direct mapping of the cache to the screen buffer is disassociated with the actual screen size setting. Since the pixels reside in consecutive memory addresses from the top-left screen corner to the lower-right corner, using a 64 8-pixel line cache as an example, for a 320×240 maximum resolution, there are only 9600 cache line locations in the screen. Out of that, only 150 unique locations per line can be mapped to 28 addresses. Therefore, using a simple address translation, pixel address bits [8:3] can be used as the tag index, and bits [16:9] can be used as the tag I.D. bits.

Pixel data transfers between cache control unit 78 and main memory 16 are mediated through a bus interface block 19 (see FIG. 1). Pixel data transfer requests from other stages within the 3D graphics pipeline are also mediated through the same bus interface, in the illustrated embodiment.

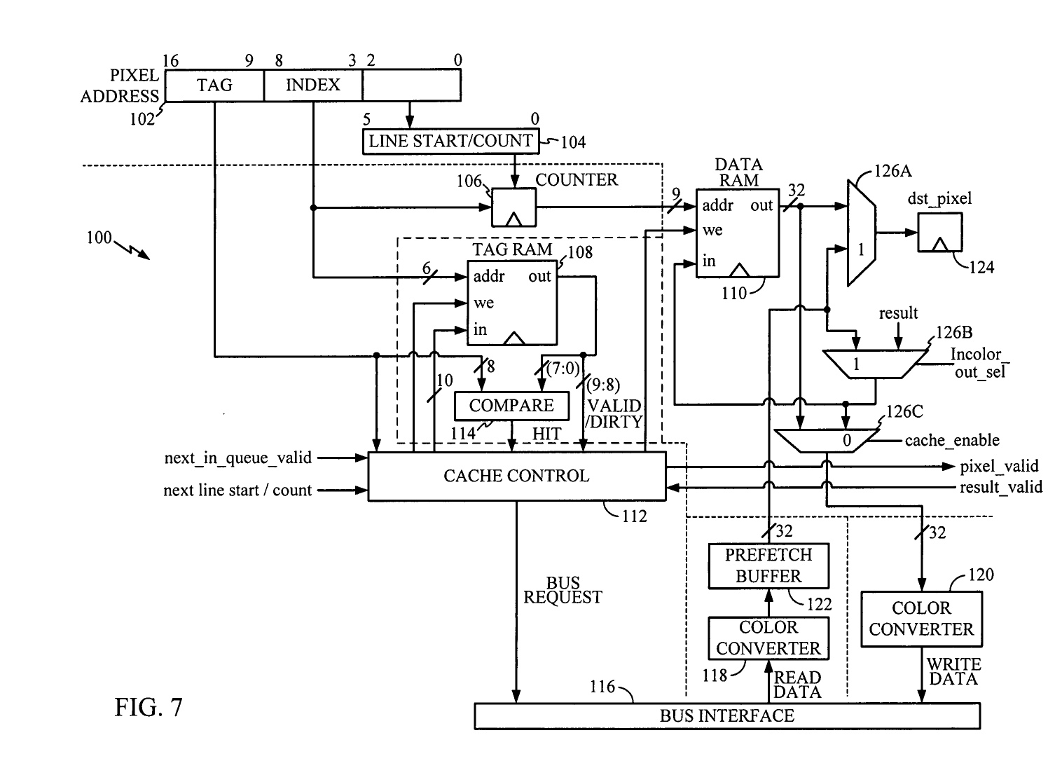

FIG. 7 is a detailed schematic diagram of a cache subsystem 100. The illustrated cache subsystem 100 comprises a pixel address register 102, a line start/count register 104, and a counter 106. In addition, a tag RAM 108, and a data RAM 110 are each provided. The illustrated cache subsystem 100 further comprises a cache control mechanism 112, a compare mechanism 114, a bus interface 116, color converters 118, 120, and a prefetch buffer 122. A register 124 is provided for storing a destination pixel. Gates 126a, 126b, and 126c are provided, for controlling data transfers from one element within cache subsystem 100 to another.

The tag portion of pixel address register 102 determines whether there is a tag hit or miss. In other words, the tag portion comprises a cache line identifier. The index portion of pixel address register 102 indicates the cache position for a given pixel address. The portion to the right of pixel address register 102, between bits 2 and 0, comprises information concerning the start to finish pixels in a given line. Line start/count register 104 receives this information, and outputs a control signal to counter 106 for controlling when data concerning the cache position is input to an address input of tag RAM 108. When cache control 112 provides a write enable signal to tag RAM 108, the addressed data will be input into tag RAM 108 through an input location “IN.” Data is output at an ouput location “OUT” of tag RAM 108 to a compare mechanism 114. The tag portion of pixel address register 102 is also input to compare mechanism 114. If the two values correspond to each other, then a determination is made that the data is in the cache and a hit signal is input to cache control mechanism 112. Depending upon the output of tag RAM 108, a valid or dirty signal will also be input into cache control 112.

Cache control mechanism 112 further receives a next in queue valid signal indicating that a queue access address is valid, and a next line start/count signal indicating that a next line within the cache is being started, and causing a reset of the count for that line.

Data RAM 110 is used for cache data storage. Tag RAM 108 stores cache line identifiers. Gate 126a facilitates the selection between the cache data storage at data RAM 110 and the prefetch buffer 122, for outputting the selected pixel in destination pixel register 124. A cache enable gate 126c controls writing of data back to the main memory through bus interface 116. Color converters 118 and 120 facilitate the conversion of the precision of the pixels from one resolution to another as data is read in through bus interface 116, or as it is written back through bus interface 116.

In cache subsystem 100, the pixel addresses coming into pixel address register 102 are bundled into cache line accesses. Cache control mechanism 112 determines if the address at the top of this queue is a cache hit or miss. If this address is a hit, cache line access is pushed onto a hit buffer. Two physical banks of the cache data RAM 110 may be provided in the prefetch cache, one for RGB and the other for alpha. The alpha bank is disabled (clock-gated) if the alpha buffer is disabled and if the output format is in the RGB mode. Otherwise, both alpha and color may be fetched to maintain the integrity of the cache. The input data to the data path and blending portion 74 of the circuit shown in FIG. 4 may be from data RAM 110 or from prefetch buffer 122 depending on whether the cache line access is a hit or a miss.

As illustrated above, referring to, for example, FIGS. 1, 2, and 4, frame buffer prefetch cache 84 is a pixel-centric write-back data cache with a prefetch mechanism 91, located between the pixel rendering output (the output of the shading stage) and the bus interface 19 of the 3D graphics entity. The linear pixel index may be the index that is generated from the rendering process performed by shading stage 25 (see FIG. 2). Those linear pixel indices are grouped into cache line accesses and are queued in a cache line access queue, such as triangle pixel address buffer 76 in FIG. 4. A cache hit or miss is checked on a per-cache-line basis. The cache line size is pixel-based rather than memory-based, representing consecutive pixels in a linear memory space, disassociating the cache from varying frame buffer formats in the possible different operating environments. Alternatively, the cache line may be non-linear. For example, a given cache line may correspond to a rectangular portion of the image, rather than a complete horizontal line scanned across the image.

Prefetching mechanism 86 attempts to take advantage of the processing time needed in the portion of the pixel blending process not yet requiring per-pixel processing. Specifically, as indicated at act 56 in the process shown in FIG. 3, while the process actions not requiring triangle pixels are being commenced by the blending process, the triangle pixels can be prefetched by the prefetch mechanism 91, as indicated by act 54, which specifies that the triangle pixels are stored locally. This can be done on a cache line-by-cache line basis. Accordingly, the acts 52 and 58 shown in FIG. 3 may be performed not only for a given triangle, but may be repeated for each cache line required for all of the pixels of the given triangle.

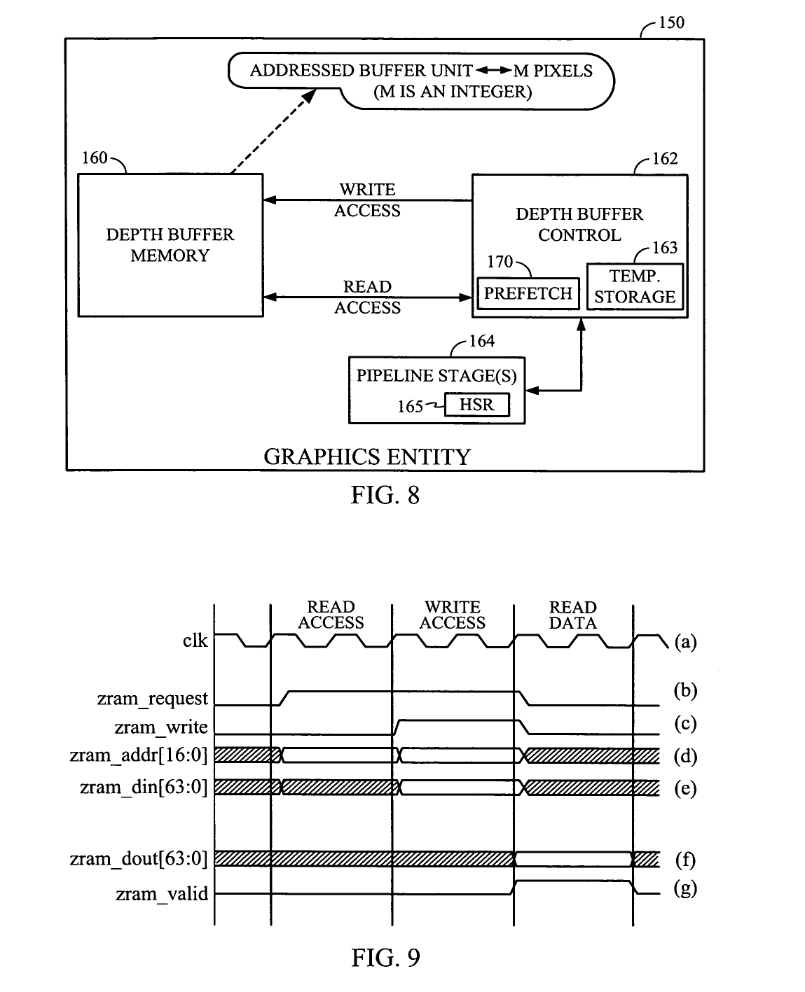

FIG. 8 illustrates a graphics entity 150, comprising, among other elements, one or more pipeline stages 164, a depth buffer control 162, and a depth buffer memory 160. Depth buffer memory 160 is local to the graphics entity (in the embodiment, embedded in the same IC as the graphics entity), and buffers depth values for access by the pipeline stages, particularly a hidden surface removal stage 165. Depth buffer control 162 facilitates writes and reads, and comprises a temporary storage 163.

The number of cycles required for a read exceeds the number of cycles required for a write. Accordingly, whenever a write request is made, for example, by the hidden surface removal stage 165, the write is postponed by storing the write data in temporary storage 163, until such time as a read access is requested by hidden surface removal stage 165.

This allows the read latency to be hidden, by overlapping the writing of data to the depth buffer memory 160 with the time between which a read access is made and the time at which the data to be read is transferred from depth buffer memory 160 to the requesting entity, in this case, the hidden surface removal pipeline stage 165.

As illustrated in FIG. 8, the depth buffer memory is organized so that an addressed buffer unit (e.g., a buffer addressable buffer line) stores a given number of pixels, that number being any integer value M. The depth buffer memory addressed buffer units may correspond to pixels in the manner described above with respect to FIG. 5.

A prefetching mechanism 170 may be provided to prefetch depth values from the depth buffer memory 160 and store those values in temporary storage 163. Accordingly, when a hidden surface removal stage 165 requests a given depth value, temporary storage 163, functioning as a cache, may not have this pixel depth value, resulting in a “miss,” prompting prefetching mechanism 170 to obtain the requested depth value. Prefetching mechanism 170 prefetches a number of values, i.e., M values, by requesting a complete addressed buffer unit.

FIG. 9 is a timing diagram illustrating the read and write timing for the depth buffer memory illustrated in FIG. 8. Waveform (a) is a clock signal, which can be used to control certain functions of the hidden surface removal stage 165 and depth buffer control 162, and depth buffer memory 160. Waveform (b) is a request signal sent from the hidden surface removal stage 165 to depth buffer control mechanism 162, indicating that the hidden surface removal stage should take priority, other requests should be ignored, and that accesses are being made to the depth buffer memory 160, involving the input of addresses to depth buffer control mechanism 162. The next waveform (c) is a write signal, indicating that a write address is being input during the time period at which that signal is high. Waveform (d) is the waveform within which the address information is provided by the hidden surface removal stage to the depth buffer control mechanism. Waveform (e) is the waveform within which the data to be written is input to the depth buffer control mechanism. Waveform (f) is the waveform output by the depth buffer control mechanism in response to the read access. Waveform (g) is an output data valid signal, which is high when the data being output by the depth buffer control mechanism to the hidden surface removal stage is valid. As shown in FIG. 9, during a first of three epochs, a read access is made. During the second epoch, a write access is made. The data is written to the depth buffer memory during the second epoch as shown in waveform (e), and the data is read from the depth buffer memory in the third epoch as shown in waveform (f).

Each element described hereinabove may be implemented with a hardware processor together with computer memory executing software, or with specialized hardware for carrying out the same functionality. Any data handled in such processing or created as a result of such processing can be stored in any type of memory available to the artisan. By way of example, such data may be stored in a temporary memory, such as in a random access memory (RAM). In addition, or in the alternative, such data may be stored in longer-term storage devices, for example, magnetic disks, rewritable optical disks, and so on. For purposes of the disclosure herein, a computer-readable media may comprise any form of data storage mechanism, including such different memory technologies as well as hardware or circuit representations of such structures and of such data.

While the invention has been described with reference to certain embodiments, the words which have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such as are within the scope of the appended claims.

1. An embedded device, comprising:
a device memory and hardware entities connected to the device memory, at least some of the hardware entities to perform actions involving access to and use of the device memory, and the hardware entities comprising a 3D graphics entity; and
a grid cell value buffer separate from the device memory, to hold data, including buffered grid cell values, portions of the 3D graphics entity accessing the buffered grid cell values in the grid cell value buffer, in lieu of the portions directly accessing the grid cell values in the device memory, for per-grid cell processing by the portions.

2. The embedded device according to claim 1, wherein the grid cell value buffer comprises a pixel buffer, the grid cell values comprise pixels, and the per-grid cell processing comprises per-pixel processing.

3. The embedded device according to claim 2, further comprising a bus, the device memory being connected to and accessible by the hardware entities through the bus.

4. The embedded device according to claim 3, wherein the bus comprises a system bus, and wherein the device memory comprises a main memory.

5. The embedded device according to claim 4, wherein the 3D graphics entity further comprises a graphics pipeline and a graphics clock, the graphics pipeline comprising a primitive-to-pixel conversion portion and later portions succeeding the primitive-to-pixel conversion portion, and data exchanges within the 3D graphics entity being clocked at the graphics clock rate.

6. The embedded device according to claim 5, wherein the 3D graphics entity comprises a chip.

7. The embedded device according to claim 5, wherein the 3D graphics entity comprises a 3D graphics core of a larger integrated system on a chip.

8. The embedded device according to claim 5, wherein the 3D graphics entity further comprises a bus interface to interface the 3D graphics entity with the bus.

9. The embedded device according to claim 8, wherein the graphics clock rate is faster than a clocked data exchange rate of the bus.

10. The embedded device according to claim 5, wherein the pixel buffer comprises a cache.

11. The embedded device according to claim 10, wherein the cache is internal to the 3D graphics entity which comprises a chip distinct from the device memory, from the bus, and from others of the hardware entities.

12. The embedded device according to claim 10, wherein the cache is dedicated to data used in per-pixel processing by the 3D graphics entity.

13. The embedded device according to claim 12, wherein the data used in per-pixel processing comprises frame buffer data.

14. The embedded device according to claim 10, wherein the cache comprises a pixel prefetch mechanism to prefetch pixels from a frame buffer in the device memory.

15. The embedded device according to claim 14, wherein the prefetch mechanism comprises a mechanism to prefetch groups of pixels associated with each other and grouped together in a pixel address queue local to the 3D graphics entity.

16. The embedded device according to claim 14, wherein the later portions of the graphics pipeline and the shading portion of the graphics pipeline each comprise stages of the graphics pipeline.

17. The embedded device according to claim 14, wherein the later portions of the graphics pipeline comprise a texturing portion.

18. The embedded device according to claim 14, wherein the later portions of the graphics pipeline comprise a blending portion.

19. The embedded device according to claim 14, wherein the later portions of the graphics pipeline comprise both texturing and blending portions.

20. The embedded device according to claim 14, further comprising a post-primitive-to-pixel conversion (post-conversion) graphics processing portion, the post-conversion graphics processing portion of the graphics pipeline comprising a per-object processing portion, the per-object processing portion and the cache collectively comprising a new object enable mechanism to enable new object prefetching by the cache of pixels of a new object, the per-object processing portion processing portions of the new object to produce new object pixels, where pixels from a previously processed different object coinciding with the new object pixels are already in the cache at the time of the new object prefetching, and where the cache does not prefetch the coinciding pixels.

21. The embedded device according to claim 20, wherein each object comprises a triangle.

22. The embedded device according to claim 14, wherein the cache comprises a write-back mechanism to write back a processed given pixel to replace the unprocessed version of the same given pixel in a frame buffer external to the 3D graphics entity.

23. The embedded device according to claim 22, wherein the frame buffer is in the main memory of the embedded device and is accessed by the cache via the system bus.

24. The embedded device according to claim 14, wherein the cache comprises cache line accesses, each cache line access corresponding to a plural set of linear pixel indices generated from the primitive-to-pixel conversion portion of the graphics pipeline.

25. The embedded device according to claim 1, wherein the embedded device comprises a mobile device.

26. The embedded device according to claim 1, wherein the embedded device comprises a wireless communications device.

27. The embedded device according to claim 1, wherein the embedded device comprises a mobile phone.

28. The embedded device according to claim 1, wherein the grid cell value buffer comprises a depth buffer, and wherein the grid cell values comprising depth values.

29. The embedded device according to claim 28, wherein the 3D graphics entity comprises a hidden surface removal portion that accesses the depth values in the depth buffer, in lieu of the hidden surface removal portion directly accessing the depth values in the device memory, for per-grid-cell processing by the hidden surface removal portion.

30. The embedded device according to claim 29, wherein the depth buffer comprises a depth value prefetch mechanism to prefetch depth values from a buffer in the device memory.

31. The embedded device according to claim 30, wherein the depth value prefetch mechansim comprises a mechanism to prefetch groups of depth values associated with each other.

32. The embedded device according to claim 30, wherein the depth buffer comprises addressable units, each addressable unit comprising an integer M depth values.

33. The embedded device according to claim 29, comprising a mechanism to defer a given write to the depth buffer memory until a read access to the depth buffer memory occurs.

34. An integrated circuit comprising:
3D graphics processing portions; and
a grid cell value buffer to hold data, including buffered grid cell values, the portions accessing the buffered grid cell values in the grid cell value buffer, in lieu of the portions directly accessing the grid cell values in a separate device memory and in lieu of accessing a system bus required to access the separate device memory, for per-grid cell processing by the portions.

35. The integrated circuit according to claim 34, wherein the grid cell value buffer comprises a pixel buffer, the grid cell values comprise pixels, and the per-grid cell processing comprises per-pixel processing.

36. The integrated circuit according to claim 35, wherein the pixel buffer comprises a prefetch cache, the prefetch cache comprising addressable units, each addressable unit comprising an integer number of pixels.

37. The integrated circuit according to claim 34, wherein the grid cell value buffer comprises a depth buffer, and wherein the grid cell values comprise depth values.

38. The integrated circuit according to claim 37, comprising a mechanism to defer a given write to the depth buffer memory until a read access to the depth buffer memory occurs.

39. Machine-readable media, interoperable with a machine to:
perform 3D graphics processing with processing portions of an embedded system;
hold data, including buffered grid cell values, in a grid cell value buffer; and
cause the processing portions to access the buffered grid cell values in the grid cell value buffer, in lieu of the processing portions directly accessing the grid cell values in a separate device memory and in lieu of accessing a system bus required to access the separate device memory, for per-grid cell processing by the processing portions.

40. The machine-readable media according to claim 39, wherein the grid cell value buffer comprises a pixel buffer, the grid cell values comprise pixels, and the per-grid cell processing comprises per-pixel processing.

41. The machine-readable media according to claim 40, wherein the pixel buffer comprises a prefetch cache, the prefetch cache comprising addressable units, each addressable unit comprising an integer number of pixels.

42. The machine-readable media according to claim 39, wherein the grid cell value buffer comprises a depth buffer, and wherein the grid cell values comprise depth values.

43. The machine-readable media according to claim 42, interoperable with the machine to:
defer a given write to the depth buffer memory until a read access to the depth buffer memory occurs.

44. Apparatus comprising:
3D graphics processing means for performing 3D graphics processing; and
buffer means for holding data, including buffered grid cell values, the 3D graphics processing means further comprising means for accessing the buffered grid cell values in the buffer, in lieu of the 3D graphics processing means directly accessing the grid cell values in a separate device memory and in lieu of the 3D graphics processing means accessing a system bus required to access the separate device memory, and the 3D graphics processing means comprising means for performing per-grid cell processing.

45. The apparatus according to claim 44, wherein the buffer means comprise a pixel buffer, the grid cell values comprise pixels, and the per-grid cell processing means comprise means for performing per-pixel processing.

46. The apparatus according to claim 45, wherein the buffer means comprise prefetch means for performing prefetch caching of pixels accessed by the 3D graphics processing means, the prefetch means comprising means for receiving data requests in addressable units, each addressable unit comprising an integer number of pixels.

47. The apparatus according to claim 44, wherein the buffer means comprise means for buffering depth values, and wherein the grid cell values comprise the depth values.

48. The apparatus according to claim 47, further comprising means for deferring a given write to the means for buffering depth values until a read access to the means for buffering depth values occurs.
